(19) United States
(12) Patent Application Publication
(10) Pub. No.: US 2024/0311883 A1
(43) Pub. Date: Sep. 19, 2024

(54) Composite Pricing System

(71) Applicant: Junk Car Pricer LLC, Chattanooga, TN (US)

(72) Inventors: Gary Michael Brock, Chattanooga, TN (US); Michael Joseph Mack, Santa Rosa, CA (US)

(21) Appl. No.: 18/606,367

(22) Filed: Mar. 15, 2024

Related U.S. Application Data
(60) Provisional application No. 63/452,577, filed on Mar. 16, 2023.

(51) Int. Cl. G06Q 30/0283; G06Q 30/0601

(52) U.S. Cl. CPC G06Q 30/0283; G06Q 30/0641

(57) ABSTRACT

A solution for pricing a mechanism comprising numerous components is provided. A price for each component is separately determined. A price for at least one component can be based on a material price for a recyclable quantity of materials included in the component. The material price can be retrieved from a material pricing database that is managed and can be updated periodically. Identifying information for the mechanism can be used to determine the corresponding components and the recyclable quantity of material included in one or more of the components. A composite price can be calculated from the price(s) for each of the components and provided for use by a user, e.g., to potentially transfer ownership of the mechanism.

### REFERENCE TO RELATED APPLICATIONS

The current application claims the benefit of U.S. Provisional Application No. 63/452,577, filed on 16 Mar. 2023, which is hereby incorporated by reference.

### TECHNICAL FIELD

The disclosure relates generally to using real time, geographically dependent data in generating pricing information for a mechanism, such as a vehicle, including multiple components with independent value.

### BACKGROUND ART

Individuals often want to know the value of a vehicle that is no longer desired. For example, the value of the vehicle may be desired in order to negotiate a sale or purchase of the vehicle when the vehicle is no longer useful to its current owner. In such a case, the vehicle may be purchased or sold in order to recycle one or more of its constituent components. For this situation, the overall value of the vehicle is generally dependent on the combined values of the recyclable components thereof.

### SUMMARY OF THE INVENTION

For mechanisms, including vehicles, the value of a component can vary according to numerous factors, including a manufacturer, make, and model of the vehicle, any options which may be included, a running condition of vehicle, etc. Additionally, many component values may vary significantly based on the geographic area in which the vehicle, and therefore the component, is or will be located, a buyer's fluctuating interest in purchasing the component, etc. Still further, a value of a component may be subject to frequent updates, e.g., due to fluctuations in a corresponding trading market (e.g., spot pricing) for one or more materials, such as precious metals, that can be recovered from the component.

Aspects of the invention provide a solution for generating pricing information for a mechanism based on the combined values of components of the mechanism which can be recycled, scrapped, resold, and/or the like. In an illustrative implementation described in detail herein, the mechanism is a vehicle. However, it is understood that aspects of the invention can be applied to any of various mechanisms for which components thereof have value separate from their implementation in the mechanism.

As mechanisms, particularly vehicles, and the components thereof become more expensive, a likelihood of the mechanism's value as a useful article falling below a combined value of its separate salvageable components increases. Such a situation can occur due to replacement cost of one or more components that has been damaged or worn beyond its useful life, outdated technology used in the mechanism, etc. As a result, the ability to effectively recover components for reuse and/or recycling becomes increasingly important. However, the transfer of a mechanism to an individual or entity having the expertise to accomplish the component-based reuse and recovery of the mechanism remains difficult to accomplish. A major block is in determining fair pricing for the mechanism as the pricing for some of the components can fluctuate according to global pricing. This can result in frustration on the part of sellers and buyers of the mechanisms due to errors in the pricing.

A first aspect of the invention provides a computer system for pricing a mechanism, the computer system including: a set of computing devices configured to provide at least one composite price for the mechanism by: managing a material pricing database for a plurality of materials, wherein the material pricing database includes a price for a quantity of each of the plurality of materials; obtaining identifying information for the mechanism, wherein the identifying information defines a plurality of components included in the mechanism, and the plurality of components includes at least one materials-based component having a corresponding recyclable quantity of a material of the plurality of materials included in the materials-based component; determining at least one price for each component of the plurality of components, wherein determining one of the at least one price for a materials-based component of the plurality of components includes determining a price for the corresponding recyclable quantity of the material included in the materials-based component; calculating at least one composite price based on the determined at least one price for each of the plurality of components; and providing the at least one composite price for use by a user.

A second aspect of the invention provides a computer system for managing a transfer of a mechanism, the computer system including: a set of computing devices configured to arrange a transfer of the mechanism from a first owner to a second owner by: providing at least one composite price for the transfer of the mechanism by: managing a material pricing database for a plurality of materials, wherein the material pricing database includes a price for a quantity of each of the plurality of materials; obtaining identifying information for the mechanism, wherein the identifying information defines a plurality of components included in the mechanism, and the plurality of components includes at least one materials-based component having a corresponding recyclable quantity of a material of the plurality of materials included in the materials-based component; determining at least one price for each component of the plurality of components, wherein determining one of the at least one price for a materials-based component of the plurality of components includes determining a price for the corresponding recyclable quantity of the material included in the materials-based component; calculating at least one composite price based on the determined at least one price for each of the plurality of components; and providing the at least one composite price for use by a user; receiving transfer data corresponding to the transfer from the user, wherein the transfer data includes a location of the mechanism and an agreed price for the mechanism; and initiating a transfer of possession of the mechanism using the transfer data.

A third aspect of the invention provides a computer system for managing a transfer of a vehicle, the computer system including: a set of computing devices configured to arrange a transfer of the vehicle from a first owner to a second owner by: providing at least one composite price for the transfer of the vehicle by: managing a material pricing database for a plurality of materials, wherein the material pricing database includes a price for a quantity of each of the plurality of materials; obtaining identifying information for the vehicle, wherein the identifying information defines a plurality of components included in the vehicle, and the plurality of components includes at least one materials-based component having a corresponding recyclable quantity of a material of the plurality of materials included in the materials-based component; determining at least one price for each component of the plurality of components, wherein determining one of the at least one price for a materials-based component of the plurality of components includes determining a price for the corresponding recyclable quantity of the material included in the materials-based component; calculating at least one composite price based on the determined at least one price for each of the plurality of components; and providing the at least one composite price for use by a user; receiving transfer data corresponding to the transfer from the user, wherein the transfer data includes a location of the vehicle and an agreed price for the vehicle; and initiating a transfer of possession of the vehicle using the transfer data.

Other aspects of the invention provide methods, systems, program products, and methods of using and generating each, which include and/or implement some or all of the actions described herein. The illustrative aspects of the invention are designed to solve one or more of the problems herein described and/or one or more other problems not discussed.

### BRIEF DESCRIPTION OF THE DRAWINGS

These and other features of the disclosure will be more readily understood from the following detailed description of the various aspects of the invention taken in conjunction with the accompanying drawings that depict various aspects of the invention.

FIG. 1 shows an illustrative environment for generating pricing information for a mechanism according to an embodiment.

FIG. 2 shows an illustrative schematic diagram of a vehicle pricing system according to an embodiment.

FIG. 3 shows an illustrative flow diagram for managing a vehicle purchase according to an embodiment.

FIG. 4 shows an illustrative input screen interface, which can be presented on a user system, such as a mobile device, according to an embodiment.

FIG. 5 shows an illustrative output screen interface presented on a user system according to an embodiment.

FIG. 6 shows illustrative calculations that can be performed by the vehicle pricing system in order to generate a value of a vehicle as described herein.

FIG. 7 shows another illustrative input screen interface presented on a user system according to an embodiment.

FIG. 8 shows another illustrative output screen interface presented on a user system according to an embodiment.

FIG. 9 shows an illustrative driver administration screen interface presented on a user system according to an embodiment.

FIGS. 10A and 10B show illustrative dispatch input screen interfaces presented on a user system according to an embodiment.

FIG. 11 shows an illustrative dispatch output screen interface presented on a user system according to an embodiment.

FIG. 12 shows an illustrative driver input screen interface presented on a user system according to an embodiment.

FIG. 13 shows an illustrative driver output screen interface presented on a user system according to an embodiment.

FIG. 14 shows an illustrative main office input screen interface presented on a user system according to an embodiment.

It is noted that the drawings may not be to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, aspects of the invention provide a solution for generating pricing information for a mechanism based on the combined values of components of the mechanism which can be recycled, scrapped, resold, and/or the like. In an illustrative implementation, the mechanism is a vehicle. However, it is understood that aspects of the invention can be applied to any of various mechanisms for which components thereof have value separate from their implementation in the mechanism.

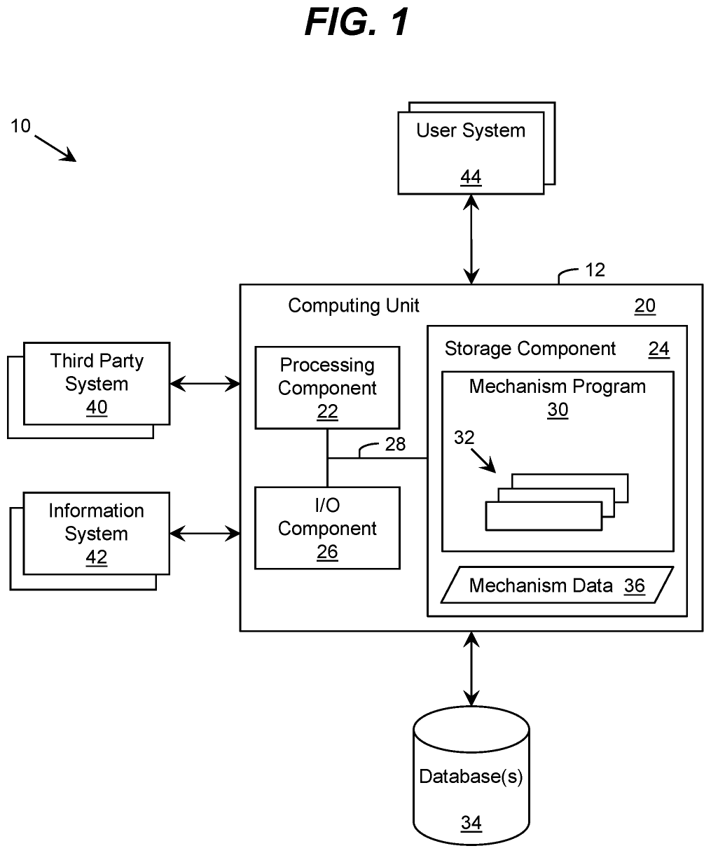

Turning to the drawings, FIG. 1 shows an illustrative environment 10 for generating pricing information for a mechanism according to an embodiment. To this extent, the environment 10 includes a pricing system 12, which can receive data from one or more third party systems 40, one or more information systems 42, one or more user systems 44, and/or the like, and generate mechanism data 36, which the pricing system 12 can provide for processing by the user system 44. The mechanism data 36 can include information corresponding to a price of the mechanism and/or one or more components thereof. The mechanism data 36 also can include information that can be utilized to complete a transaction involving the mechanism and/or one or more components thereof.

The pricing system 12 can include any configuration of computing hardware that is capable of generating pricing information as described herein. For example, as illustrated, the pricing system 12 can be implemented as a computing unit 20, which is configured to execute a mechanism program 30 in order to generate pricing information for a mechanism and provide the pricing information for processing by the user system 44 as described herein. To this extent, the computing unit 20 is shown including a mechanism program 30, which makes the computing unit 20 operable to generate pricing information for the mechanism by performing a process described herein.

The computing unit 20 is shown including a processing component 22 (e.g., one or more processors), a storage component 24 (e.g., a storage hierarchy, which can include one or more types of memory, storage drives, etc.), an input/output (I/O) component 26 (e.g., one or more I/O interfaces and/or devices), and a communications pathway 28. In general, the processing component 22 executes program code, such as the mechanism program 30, which is at least partially fixed in storage component 24. While executing program code, the processing component 22 can process data, which can result in reading and/or writing transformed data from/to the storage component 24, one or more databases 34, and/or the I/O component 26 for further processing. The pathway 28 provides a communications link between each of the components in the computing unit 20.

The I/O component 26 can comprise one or more human I/O devices, which enable a human user to interact with the computing unit 20 and/or one or more communications devices to enable another computer system, such as the user system 44, to communicate with the computing unit 20 using any type of communications link. To this extent, the mechanism program 30 can manage a set of interfaces (e.g., graphical user interface(s), application program interface, and/or the like) that enable human and/or computer systems to interact with the mechanism program 30. Furthermore, the mechanism program 30 can manage (e.g., store, retrieve, create, manipulate, organize, present, etc.) the data, such as mechanism data 36, using any solution.

In any event, while shown schematically as a single computing device, the computing unit 20 can comprise one or more computing devices, such as one or more general purpose computing articles of manufacture, which are collectively configured to execute the mechanism program 30 installed thereon. As used herein, it is understood that “program code” means any collection of instructions, in any language, code or notation, that cause a computing device having an information processing capability to perform a particular action either directly or after any combination of the following: (a) conversion to another language, code or notation; (b) reproduction in a different material form; and/or (c) decompression. To this extent, the mechanism program 30 can be embodied as any combination of system software and/or application software.

Furthermore, the mechanism program 30 can be implemented using a set of modules 32. In this case, a module 32 can cause the computing unit 20 to perform a set of tasks used by the mechanism program 30, and can be separately developed and/or implemented apart from other portions of the mechanism program 30. As used herein, the term “component” means any configuration of hardware, with or without software, which implements the functionality described in conjunction therewith using any solution, while the term “module” means program code that enables a computing unit 20 to implement the actions described in conjunction therewith using any solution. When fixed in a storage component 24 of a computing unit 20 that includes a processing component 22, a module is a substantial portion of a component that implements the actions. Regardless, it is understood that two or more components, modules, and/or systems may share some/all of their respective hardware and/or software. Furthermore, it is understood that some of the functionality discussed herein may not be implemented or additional functionality may be included as part of the computing unit 20.

It is understood that the computing unit 20 and the mechanism program 30 are only representative of various possible equivalent implementations of the pricing system 12 using one or more computing units. To this extent, in other embodiments, the functionality provided by the computing unit 20 and the mechanism program 30 can be at least partially implemented by one or more computing units that include any combination of general and/or specific purpose hardware with or without program code. In each embodiment, the hardware and program code, if included, can be created using standard engineering and programming techniques, respectively.

Regardless, communications between two or more computing devices, such as between the computing unit 20 and the user system 44 and/or between multiple computing units implementing the pricing system 12, can use any combination of various types of communications links. A communications link can comprise any combination of various types of optical fiber, wired, and/or wireless links; comprise any combination of one or more types of networks (e.g., public and/or private); and/or utilize any combination of various types of transmission techniques and protocols.

As discussed herein, the pricing system 12 is configured to generate pricing information for a mechanism by processing and combining data from various types of sources. For example, the pricing system 12 can acquire data from one or more third party systems 40 using any solution. The third party system 40 can be utilized by one or more entities which are interested in buying the mechanism or one or more components thereof. The third party system 40 can provide data corresponding to an amount that the entity is willing to pay for the mechanism and/or the component(s). Furthermore, the third party system 40 can provide additional data regarding the entity, which can be provided by the entity through any type of interface, such as a geographic location of the entity, a geographic region in which the entity is willing to make purchases, and/or the like.

Furthermore, the pricing system 12 can acquire real time pricing data from one or more information systems 42. For example, an information system 42 can provide real time pricing data for one or more commodities, such as precious metals, which may be recoverable from one or more components of the mechanism. Pricing system can monitor the spot price of one or more of such commodities on one or more commodity exchanges. When multiple exchanges are monitored, the pricing system 12 can use a combination of the spot prices, such as an average, as a current real time price for the commodity. In embodiments, the pricing system 12 acquires the real time pricing data in predetermined time increments, such as once an hour, once every five minutes, etc. The real time pricing data also can include data regarding a required volume, a purity, a location, and/or the like, for the corresponding pricing data. These factors, as well as other external factors including, but not limited to, current commodity volume, futures prices, trend data, etc., can be used to adjust the spot price to determine an estimated price for the specific volume and purity of the commodity in the specific location at the current and/or a future point in time.

In embodiments, the pricing system 12 can acquire the real time pricing data in response to a request to determine a value of a component of a mechanism including a corresponding known volume of a commodity and to be available at a known location. It is understood that the pricing data received from an information system 42 can be updated less frequently. For example, the pricing data can be provided by an information system 42 of a scrap metal buyer or the like, which can update its corresponding pricing daily, weekly, at irregular intervals, etc. Alternatively, the pricing data can include streaming data that is obtained and evaluated in real time. In embodiments, the pricing system 12 can manage an interface that automatically obtains and/or automatically requests data from such an information system 42 according to the corresponding update interval.

In either case, the pricing system 12 can receive data from a third party system 40 and an information system 42 using any combination of various types of push/pull, automated/manual, etc., communication mechanisms. For example, the pricing system 12 can send a query to a third party system 40 and/or an information system 42 requesting an updated price on one or more components, commodities, etc., relating to the corresponding system 40, 42. Similarly, the pricing system 12 can receive the data as part of an automated information feed provided by the entity. In an embodiment, the pricing system 12 also can provide an interface in which a user can use a third party system 40 and/or an information system 42 to manually enter the data for use by the pricing system 12.

Regardless, data received from the third party system(s) 40 and/or information system(s) 42 can be stored in one or more databases 34, which are managed by the pricing system 12. The data can subsequently be retrieved and used to generate and provide pricing information for a mechanism in response to a request received from a user system 44.

Further details of the invention are described in conjunction with a particular embodiment in which the mechanism is a vehicle. However, it is understood that a vehicle is only illustrative of any of various types of mechanisms for which pricing information can be generated as described herein. Other types of mechanisms include computers, monitors, televisions, audio/visual equipment, appliances (e.g., refrigerator, washing machine, dryer, microwave, water heater, etc.), shop equipment (e.g., welder, compressor, etc.), small engine equipment (e.g., lawn mower, snow blower, etc.), etc. Mechanisms can be powered by an internal combustion engine, a rechargeable battery, an electrical outlet, etc.

Regardless, a vehicle typically has various components that can be salvaged upon the vehicle reaching the end of its useful life. A value of each such component can vary based on the manufacturer of the vehicle, the model of the vehicle, the year of the vehicle, etc. Furthermore, the value can vary according to the geographic location of the vehicle. Still further, the value of a component can vary according to the value of one or more parts or materials of the component for which the component is desired. One common material is the salvageable precious metals included in a component, such as a catalytic converter. Similarly, another part can include the metal used to fabricate the vehicle frame, which can be sold as scrap metal. Components that are not subject to wear or may have been more recently replaced may also have value as used parts. In embodiments, a component of an electric vehicle, such as the rechargeable battery, can include salvageable materials.

The pricing system 12 provides a solution in which prices for various components can be determined, compiled, and integrated to provide an overall value of the vehicle to a user. The user can be an individual looking to sell the vehicle, an individual looking to buy the vehicle, an individual looking to sell one or more of the components of the vehicle, and/or the like.

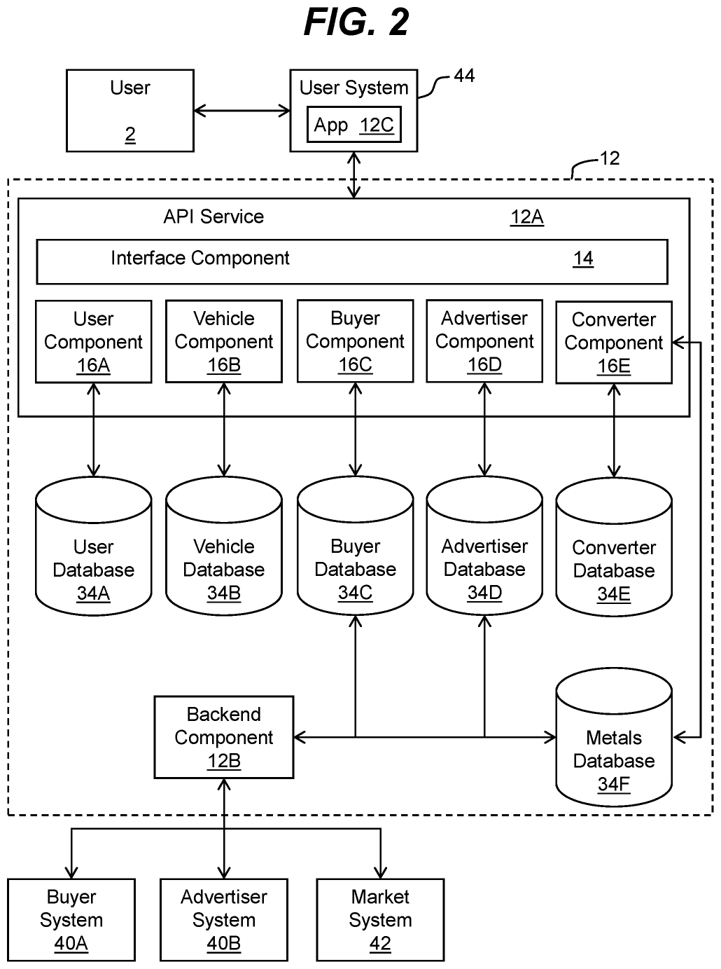

FIG. 2 shows an illustrative schematic diagram of a vehicle pricing system 12 according to an embodiment. As illustrated, the vehicle pricing system 12 can include a front end component 12A, which can be implemented as an application program interface (API) service, and a back end component 12B. While not shown, the back end component 12B also can be comprise an API service. Regardless, it is understood that the front end component 12A and/or the back end component 12B also can comprise other interfaces for receiving and updating data as described herein.

The API service 12A can comprise an interface component 14, which can communicate with various components 16A-16E, each of which is configured to query and receive data from a corresponding database 34A-34F. While separate components and databases are illustrated, it is understood that this is only for illustration and explanation of the solution described herein, and embodiments can include any number of components, any number of databases to facilitate the storage and retrieval of data, can use any alternative solution for storing and retrieving data, and/or the like.

The interface component 14 can manage communications with the user system 44 (e.g., a personal computing device), which is being utilized by a user 2. In an embodiment, the user system 44 includes an app 12C executing thereon, which is utilized by the user 2 in order to interact with the API service 12A. In embodiments, the app 12C can be a custom application, which is provided as part of the vehicle pricing system 12. The app 12C can include program code which can generate one or more of the interfaces described herein. In this case, the API service 12A can provide information necessary to generate a complete interface by the custom app 12C, and not information corresponding to the entire interface. However, it is understood that embodiments can enable the user 2 to use a third party app 12C executing on the user system 44, such as a browser, to interact with the API service 12A. In an embodiment, the API service 12A and/or the backend component 12B supports interactions using either a custom or browser app 12C executing on a third party device, such as the user system 44.

Embodiments can require the user 2 to register in order to use the vehicle pricing system 12. To this extent, the interface component 14 can generate an interface which requires the user system 44 to provide authentication data (e.g., a user name and password) in order to further utilize the vehicle pricing system 12. A user component 16A can query a user database 34A to confirm or reject the authentication data.

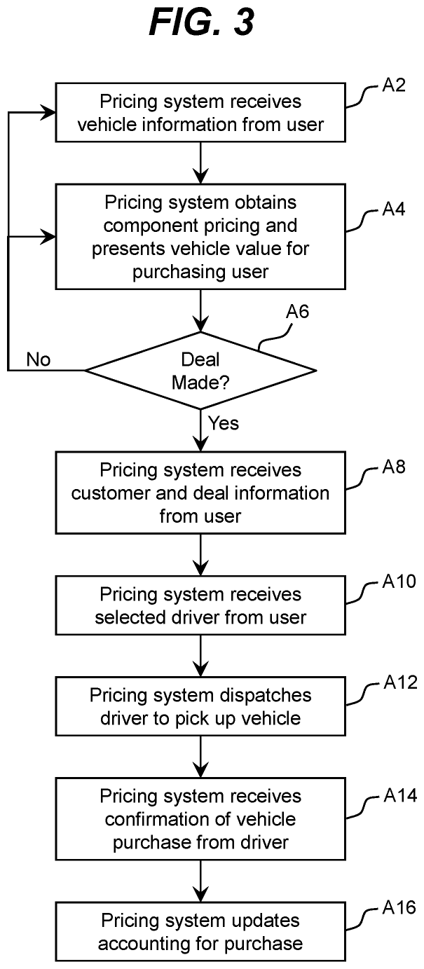

When successfully authenticated, the interface component 14 can generate an interface for presentation on the user system 44 which enables the user 2 to define the vehicle for which they are interested in obtaining pricing information. FIG. 3 shows an illustrative flow diagram for managing a vehicle purchase according to an embodiment, which can be implemented by the pricing system 12. As discussed herein, the pricing system 12 can enable the user 2 to complete the purchase using a series of user interfaces. To this extent, further aspects are described herein in conjunction with FIGS. 2 and 3 and other figures showing illustrative user interfaces. In action A2, the pricing system 12 can receive information regarding a vehicle to be priced from a user 2.

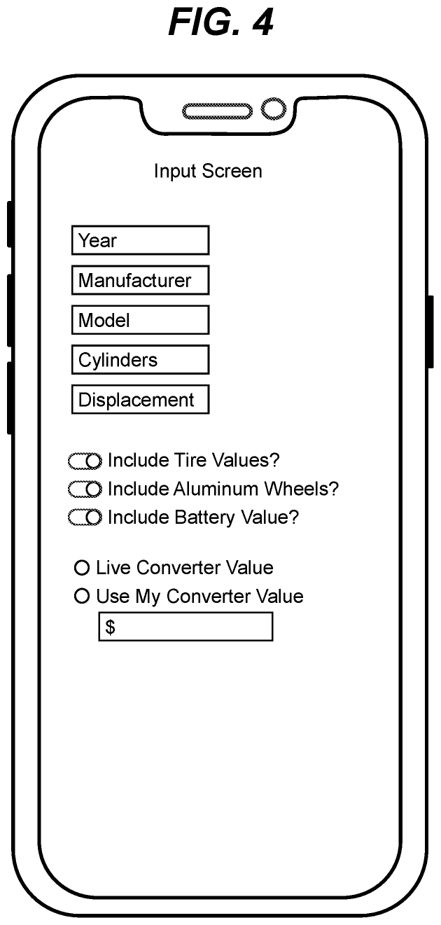

For example, FIG. 4 shows an illustrative interface presented on an illustrative user system 44, such as a mobile device, according to an embodiment. In this case, the user can define the year, manufacturer, and model of vehicle. Once provided, the interface can enable the user 2 to also select values for one or more components for which multiple possibilities exist, which can affect the value of the vehicle. Furthermore, in embodiments, the interface can enable the user 2 to provide information regarding one or more use-related items, such as a number of miles driven, maintenance actions (e.g., age of battery, miles on tires, etc.), accidents, etc.

In an embodiment, the interface component 14 can provide a list of supported values for defining the vehicle for selection by the user 2. In response to the selection of a value, the interface component 14 can update the selectable values for one or more other vehicle attributes. For example, the vehicle component 16B can query the vehicle database 34B for all years including at least one vehicle entry, and the interface component 14 can provide all vehicle years for which pricing information can be obtained for selection by the user 2 using the user system 44. In response to receiving a selected year, the vehicle component 16B can return a list of all vehicle manufacturers for which at least one vehicle is included in the vehicle database 34B for the corresponding year. Similarly, after selection of a manufacturer, the vehicle component 16B can identify all models of the manufacturer included for the selected year, etc. In this manner, the vehicle component 16B and interface component 14 can ensure that a user 2 selects a vehicle for which pricing information can be provided.

Furthermore, as illustrated in the interface shown in FIG. 4, the vehicle component 16B can enable the user 2 to define one or more options for the particular vehicle selected. For example, when multiple options are offered by a manufacturer, the user 2 can select a number of cylinders for the engine, an engine displacement, etc. In an embodiment, when a selectable input has only a single option, the interface can automatically select the option. Additionally, the interface component 14 can enable a user to selectively include or not include one or more components of the vehicle in the pricing information. For example, as illustrated in FIG. 4, example components include the tires, aluminum wheels, battery, etc.

Once the pricing system 12 has received sufficient vehicle information, in action A4, the pricing system 12 can obtain component pricing for the various components of the vehicle to be included in the pricing, and can present a vehicle value for presentation to the user 2, such as a purchasing user.

As discussed herein, a value for one or more components of a mechanism can vary based on a current market value for one or more of the materials used to fabricate the component. For example, for a vehicle, a catalytic converter's value is dependent on the market value for the recoverable metals, such as palladium, rhodium, and platinum, which are included therein. The market value can be determined from a global trading market for the corresponding material (e.g., metal) and/or from a local pricing available for selling the material, e.g., the pricing offered by one or more local purchasers of the material.

Using a catalytic converter and the metals included therein as an illustrative component and materials for which its pricing is variable, the front end component 12A can include a converter component 16E, which is configured to determine a value of a catalytic converter using current market pricing data for one or more of its metals. In this case, upon the vehicle being defined by the user 2, the converter component 16E can obtain data for the corresponding catalytic converter from a converter database 34E. For example, the converter database 34E can include information regarding the quantity of one or more metals that can be recovered from the catalytic converter used to manufacture the corresponding selected vehicle. For each such metal and quantity, the converter component 16E can determine current pricing for the metal at the corresponding quantity from a metals database 34F. The converter component 16E then can generate a value for the catalytic converter which can be included in calculating an overall value for the vehicle.

As illustrated by FIG. 4, a user can optionally provide a value for one or more of the components of a mechanism for use by the pricing system 12. For example, for a vehicle, a user 2 may know a price for which a corresponding catalytic converter can be sold. As a result, the user 2 can provide a value for the catalytic converter to be used in determining an overall value of the vehicle, rather than using a calculated value as described herein. It is understood that the catalytic converter is only an illustrative component for which the user 2 can provide the price. To this extent, the interface component 12A can enable the user 2 to provide a corresponding price for any of the components of a selected mechanism. Similarly, a user 2 also could alter a default quantity for a particular component. For example, the user 2 could indicate a number to tires included with the vehicle that differs from a default of four tires (e.g., to accommodate a vehicle with a full size spare, a tire that is missing or severely damaged, etc.).

In embodiments, the user 2 can be an individual looking to sell a vehicle, an individual looking to purchase a vehicle to sell the components thereof, and/or the like. In an embodiment, the vehicle pricing system described herein can facilitate connecting such sellers to individuals willing to buy the vehicle and/or one or more components thereof. To this extent, the backend component 12B can enable one or more buyers (e.g., using their corresponding buyer systems 40A) to register and provide information for use by the vehicle pricing system 12. For example, a buyer may be interested in purchasing vehicles or vehicle components located within a particular geographic area. In this case, when a user 2 indicates an interest in selling or buying a vehicle that is located within the geographic area of the buyer, the vehicle pricing system 12 can provide the user 2 with information regarding the buyer to facilitate a transaction therewith.

To this extent, the buyer component 16C can retrieve information on one or more buyers from a buyer database 34C for presentation to the user 2. The buyer information can include contact information, such as a name, address, telephone, etc., the particular vehicles and/or components in which the buyer is interested in purchasing, etc. Furthermore, the buyer can provide the current pricing information for the vehicles and/or components the buyer is interested in purchasing. For example, a buyer (e.g., using a buyer system 40A) may indicate a price for a battery, a tire, a rim, etc., which the buyer is currently willing to pay for a particular component. Such pricing information can be used by the vehicle component 16B in generating an overall value for a vehicle as described herein.

Additionally, the vehicle pricing system 12 can enable one or more advertisers (e.g., using their corresponding advertiser systems 40B) to register and provide information for use in generating an interface presented to the user 2. An advertiser can be a buyer who pays the vehicle pricing system 12 in order to be presented as a preferred buyer of a particular subset of vehicles and/or components of the vehicle. However, an advertiser can be any entity which desires to advertise using the vehicle pricing system 12. For example, an advertiser can be an entity that provides related services and/or sells related goods for vehicles and/or the recycling of components thereof, such as a catalytic converter metals assay, a smelter, a refiner, etc. The vehicle pricing system can 12 enable various levels of advertisers (e.g., exclusive, semi or non-exclusive, etc.), as well as enable an advertiser (using its advertiser system 40B) to define its corresponding geographic area.

To this extent, the advertiser component 16D can obtain data for one or more advertisers from the advertiser database 34D for presentation to the user 2. The advertiser data can include an advertisement defined by the advertiser and stored as an image or the like, a link to a website for the advertiser, and/or the like. The advertiser can designate which interface on which its information should be included, whether the information should be included alone or with other advertising, a maximum number of impressions for a given time period, a geographic area relevant for the advertiser, etc.

The buyer and advertiser can manage their corresponding information in the buyer database 34C and advertiser database 34D using any solution. For example, the vehicle pricing system 12 can include a similar API service that allows corresponding users for the buyers and advertisers to be authenticated and update the corresponding information using the respective buyer systems 40A and advertiser systems 40B. Additionally, the vehicle pricing system 12 can include an internal user that engages with the buyers and advertisers to update and manage their respective information. Furthermore, the vehicle pricing system 12 can obtain pricing information from a buyer system 40A in an automated fashion, such as from a website of the buyer using a web crawler, from an automated periodic push/pull data exchange between the vehicle pricing system 12 and the buyer system 40A, and/or the like.

Information for the buyer and/or advertiser can include a corresponding time period for which the information remains valid. In the event a buyer and/or advertiser fails to reconfirm or otherwise update its corresponding information prior to expiration of the time period, the vehicle pricing system 12 can flag the information as no longer current and remove the information from inclusion in determining vehicle pricing information and/or generating an interface for presentation to the user 2.

In an embodiment, the backend component 12B includes an interface that can acquire real time pricing information (e.g., a live spot price) for one or more recyclable commodities that are sold in an open market. For example, as discussed herein, various metals can be recycled from a component, such as a catalytic converter, and the pricing of each metal can fluctuate with sales completed in a market for each metal. Similarly, the pricing of other commodities, such as steel, can fluctuate due to market price fluctuations. To this extent, the backend component 12B can include an interface that obtains updated market pricing for various commodities from the market for each commodity and updates the pricing information in a database.

In particular, the backend component 12B can receive data corresponding to the current pricing of one or more metals from a market system 42 for the corresponding metal(s) and update a metals database 34F with the current pricing information. The backend component 12B can retrieve the current pricing periodically, e.g., every fifteen minutes, hour, daily, etc., retrieve the current pricing in response to a request to generate pricing for a component including a metal, such as a catalytic converter, and/or the like. In embodiments, the backend component 12B can query the market system 42 for the pricing of one or more metals, and the market system 42 can provide the requested pricing in an automated manner. However, it is understood that this is only illustrative of numerous approaches for updating data, including a batch updates, manual updates, etc.

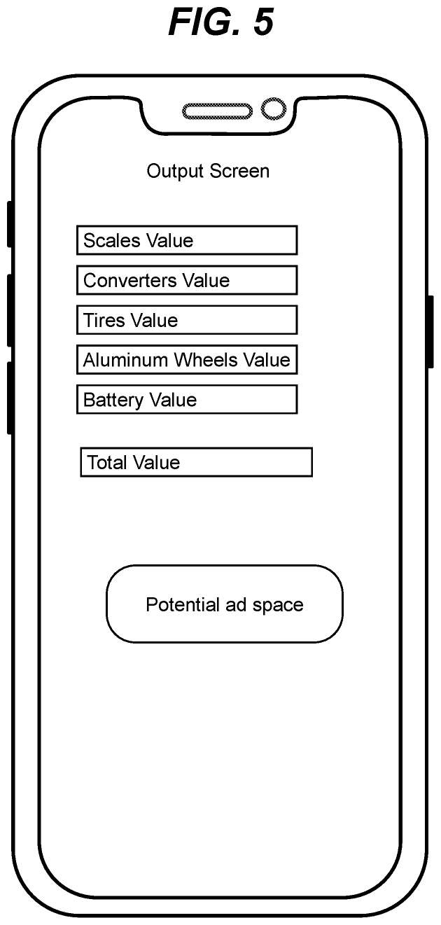

Regardless, after a user 2 defines the vehicle and options using the interface shown in FIG. 4, the vehicle pricing system 12 can compile the pricing for the various components of the vehicle and provide the pricing information for presentation to the user 2, e.g., using an interface as shown in FIG. 5. As illustrated, the pricing information can include the value of various components of the vehicle, which can include a value for the scrap steel based on a weight of the vehicle, and present the user 2 with a total value. Additionally, as discussed herein, the interface can include one or more advertisements from an advertiser, information on connecting with one or more buyers, etc.

In embodiments, the pricing system 12 can generate multiple values for a component. The values can include values determined using multiple approaches. For example, the pricing system 12 can obtain a value for the component based on a value provided by one or more local buyers of the component. Additionally, the pricing system 12 can determine a value for the component based on the combined values of parts or materials of the component, such as a combined value of the metals in a catalytic converter. In this case, the pricing system 12 can provide each value for consideration by the user 2. The user 2 can select a corresponding value to use in the pricing information. For example, the user 2 may select one of a plurality of local buyers of the component based on the prices offered, locations of the vehicle and/or the buyers, etc. Furthermore, the user 2 may select to hold on to a component or extract parts/materials from the component itself, e.g., based on the real time pricing indicating that the parts/materials have a sufficiently high value as compared to the prices being offered by the local buyers.

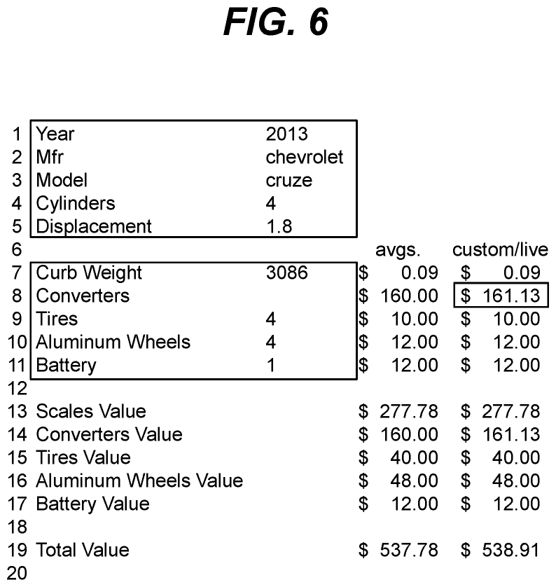

FIG. 6 shows illustrative calculations that can be performed by the vehicle pricing system 12 in order to generate a value of a vehicle as described herein. As illustrated, once the vehicle attributes are sufficiently defined (e.g., year, manufacturer, model, cylinders, engine displacement), the vehicle pricing system 12 can retrieve information affecting the vehicle price from the vehicle database 34B. Such information can include a total weight of the vehicle, as well as the more valuable recyclable components of the vehicle, such as the catalytic converter, tires, aluminum wheels, battery, etc. A total value can be calculated for each component and the values summed to provide a total value for the vehicle.

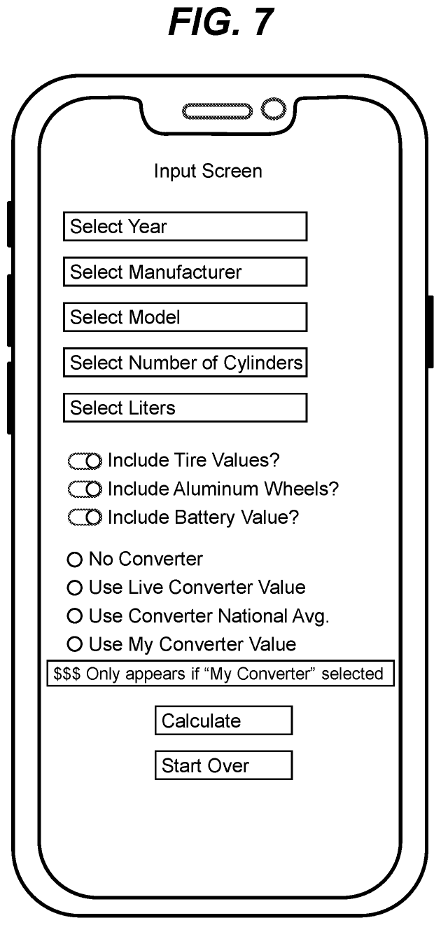

It is understood that the interfaces shown in FIGS. 4 and 5 are only illustrative of various possible interfaces. Additionally, embodiments of the vehicle pricing system 12 can enable additional actions to be performed by the user 2. To this extent, FIG. 7 shows another illustrative input screen which the vehicle pricing system 12 can generate and provide for presentation to a user 2 according to an embodiment.

In this embodiment, the interface can include sliders for selecting or deselecting various options to include for the pricing. Additionally, the interface can present various options for how the converter price, if included, is calculated. Furthermore, the interface can enable the user 2 to restart the selections by utilizing a start over button included on the interface. Regardless, once the user 2 has indicated all of the desired selections, they can request a vehicle price by selecting the calculate button.

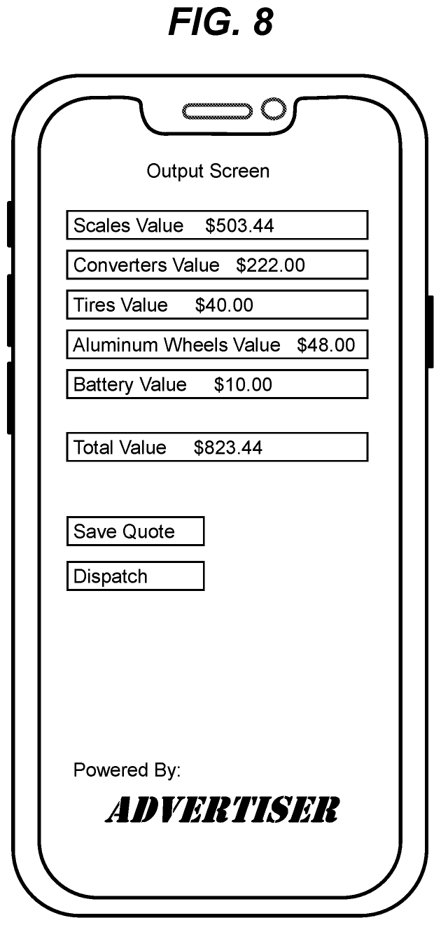

Subsequent to calculating the vehicle price, the vehicle pricing system 12 can generate an output interface to display the price. For example, FIG. 8 shows another illustrative output screen which the vehicle pricing system 12 can generate and provide for presentation to a user 2 according to an embodiment. As illustrated, the output screen can include a total value for the vehicle as well as the values for various components of the vehicle that were used to determine the total value.

In this embodiment, the user 2 also can be presented with an option to save the calculated vehicle value. If selected, the vehicle pricing system 12 can store data corresponding to the calculated vehicle value as user data associated with the user 2, e.g., in the user database 34A. Subsequently, upon being authenticated for use of the vehicle pricing system 12, an interface can be presented which enables the user 2 to view and/or retrieve one or more stored vehicle quotes. In response to a selection, the vehicle pricing system 12 can re-generate the output screen, such as the output screen shown in FIG. 8 with the vehicle price calculations. The user 2 can view additional data regarding the quote, such as a date/time when it was calculated, options and/or restrictions (e.g., geographic area) included or not included in the calculation, etc. Furthermore, the output screen can enable the user 2 to select to update the quote, e.g., with a different setting for one or more calculations, to update real time pricing for one or more components, etc.

Embodiments of the vehicle pricing system 12 can enable a user 2 to take one or more actions in order to complete the sale of the vehicle. To this extent, in action A6, the pricing system 12 can determine whether a deal has been completed for the vehicle. If no agreement has been reached, the pricing system 12 can return to action A2 (e.g., when the vehicle will not be purchased) or to action A4 (e.g., when the parties are still considering the price). In action A4, the user 2 and/or the pricing system 12 can perform one or more actions to update the price in response to one or more changes, expiration of a predetermined amount of time, etc.

When agreement has been reached to purchase the vehicle, in action A8, the pricing system 12 can receive information regarding the customer, terms of the agreement, etc. Furthermore, the pricing system 12 can enable one or more actions to complete the purchase to be initiated. To this extent, the deal information can include assigning one or more individuals to complete the purchase. For example, as illustrated in FIG. 8, the user 2 can select to dispatch another individual (e.g., an employee, a local tow truck, and/or the like) to complete the sale. In response to selecting to dispatch someone to complete the sale, the vehicle pricing system 12 can generate a dispatch input screen to enable the user 2 to provide additional details regarding the sale.

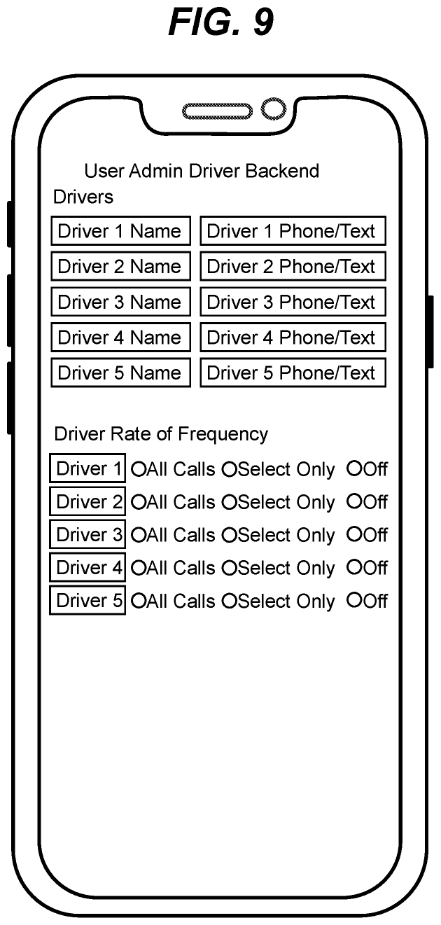

In embodiments, the pricing system 12 can enable the user 2 to manage various drivers that may be available to retrieve the vehicle. Such drivers may be employees of the user 2 or third party contractors used by the user 2. In the former case, a driver can register with the pricing system 12 as another user 2. In the latter case, the third party contractor can register with the pricing system 12 similar to a buyer and indicate his/her time availability, geographic availability, pricing, etc. FIG. 9 shows an illustrative driver administration screen interface presented on a user system according to an embodiment. As illustrated, the interface can enable the user 2 to contact a driver based on an availability of the driver. It is understood that the interface is only illustrative and can include additional information regarding a driver, such as a cost to have the driver retrieve the vehicle.

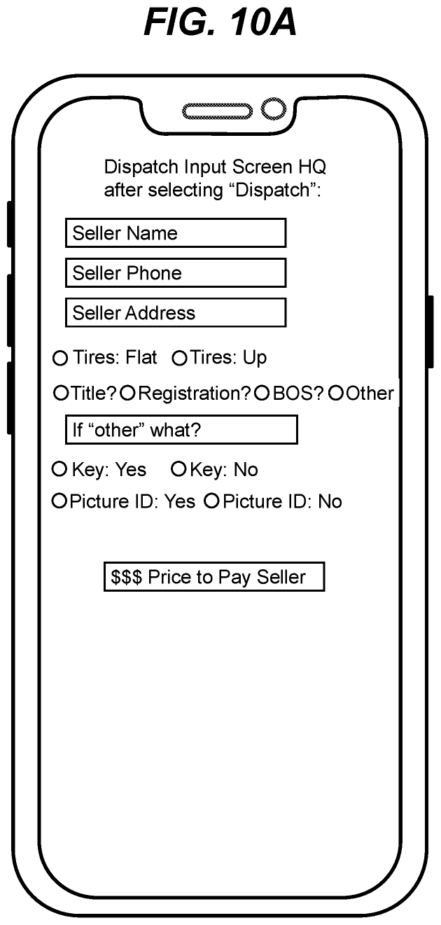

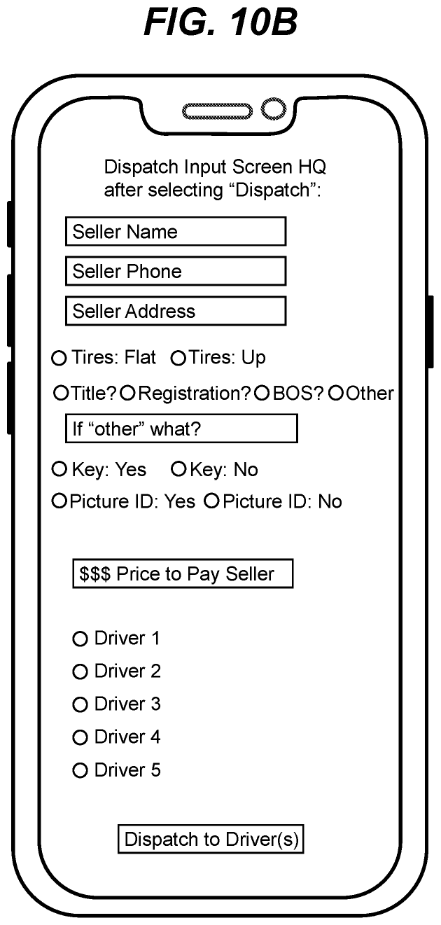

FIGS. 10A and 10B show illustrative dispatch input screens according to embodiments. Using each input screen, the user 2 can enter information regarding the seller, information regarding the vehicle and whether it is operable, information regarding documentation required to complete the sale, identification requirements for the seller, whether a key is available for the vehicle, and/or the like. Furthermore, the input screen can include an entry indicating the price to pay the seller for the vehicle. In action A10, the pricing system 12 can receive information on the driver(s) selected to retrieve the vehicle from the user 2. As shown in FIG. 10B, the input screen can further enable the user 2 to select one or more of various available drivers to retrieve the vehicle. The pricing system 12 can automatically determine the available drivers based on the information regarding the vehicle location and the operability thereof.

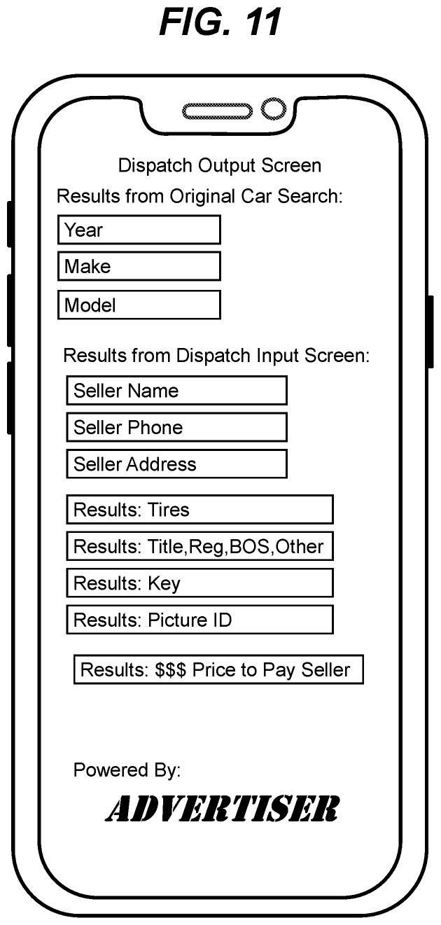

Once the dispatch data has been entered, the vehicle pricing system 12 can generate a dispatch output screen which provides all of the information for review by the user 2. For example, FIG. 11 shows an illustrative dispatch output screen which can be generated by the vehicle pricing system 12 according to an embodiment. As illustrated, the dispatch output screen can include data corresponding to the vehicle being purchased (e.g., year, make, model), the seller information, information on the accessories or working condition of the vehicle, the price, and/or the like. The user 2 can select to return to modify one or more items, cancel the dispatch, or initiate the dispatch when all of the information is acceptable.

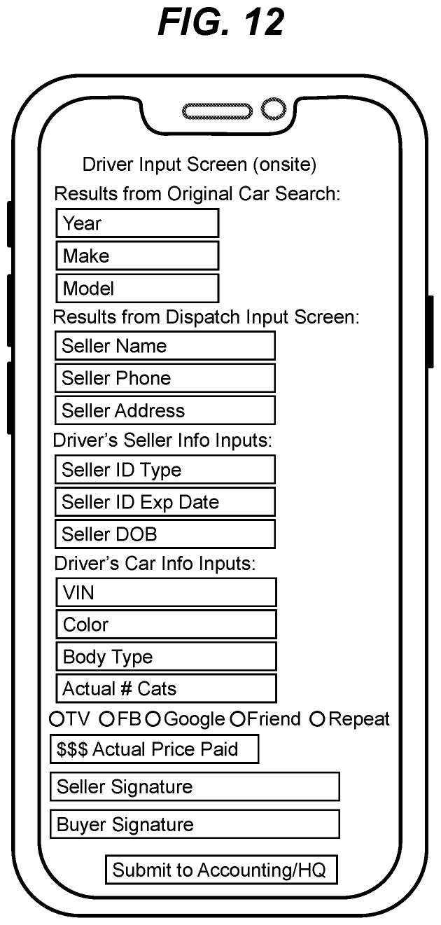

In action A12, the pricing system 12 can dispatch the driver(s) to retrieve the vehicle and complete the purchase. In response to a dispatch being initiated, the vehicle pricing system 12 can send a message to the individual being dispatched to complete the transaction. The message can include the information corresponding to the vehicle and the purchase, a link to enable the individual to access the information, and/or the like. FIG. 12 shows an illustrative driver input screen interface presented on a user system according to an embodiment. As illustrated, the interface can provide information to the driver in order to enable him/her to navigate to the location of the vehicle, confirm various aspects of the vehicle, confirm the identity of the seller, and/or the like. Furthermore, the interface can enable the driver to finalize the purchase, e.g., by providing the price paid for the vehicle and obtaining seller and buyer signatures (e.g., electronic signatures).

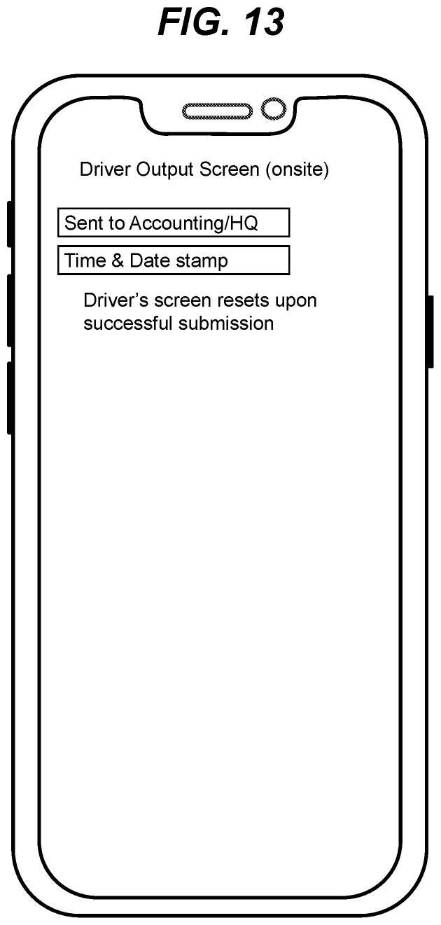

In an embodiment, the vehicle pricing system 12 can autofill a dispatch bill of sale for the dispatched individual (e.g., a truck driver) to use at the point of customer purchase. In this case, the vehicle pricing system 12 can enable the truck driver to readily access the digital bill of sale at the point of purchase from the customer selling their vehicle. Upon completion of the purchase, in action A14, the pricing system receives confirmation of the vehicle purchase from the driver. For example, the interface shown in FIG. 12 can enable the driver to generate a bill of sale and indicate the acceptance by the seller. In response, the driver can submit the purchase information for further processing. Once successfully submitted, the pricing system 12 can generate a confirmation interface for presentation to the driver. For example, FIG. 13 shows an illustrative driver output screen interface presented on a user system according to an embodiment. The interface can indicate that the purchase was successfully submitted and provide a time and date stamp for the submission. The driver can maintain a list of submissions, e.g., for compensation for the pickup.

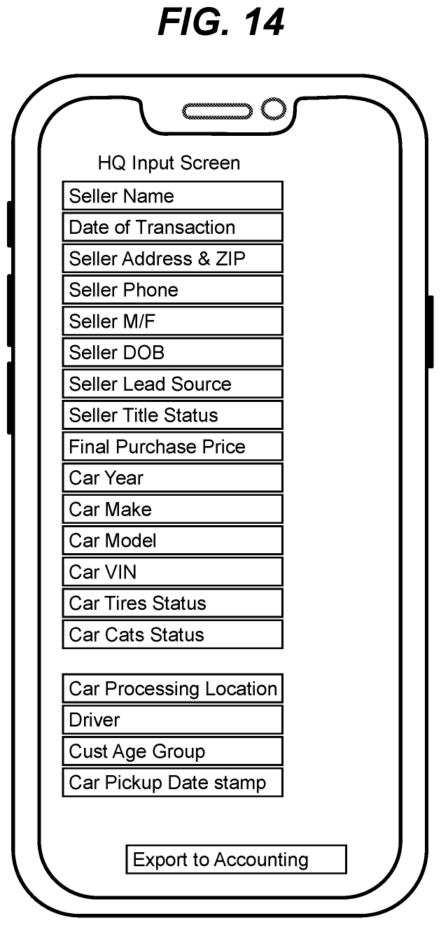

In action A16, the pricing system 12 can update accounting information for the vehicle purchase. FIG. 14 shows an illustrative main office input screen interface presented on a user system according to an embodiment. The interface can be presented by the pricing system 12 to enable a main office user 2 to confirm the information provided for the vehicle purchase. Upon confirmation of the information, the user 2 can request that the information be exported as a business record, e.g., stored in a spreadsheet including such records. The vehicle pricing system 12 can store bill of sale datapoints for use by the user 2 as business records in a dashboard, which can indicate types and makes of vehicles, dates of purchase, prices paid, advertising sources, costs and/or other accounting for the user 2.

Embodiments of the vehicle pricing system 12 can implement various features. Such features can utilize various combinations of the data stored in the databases 34A-34F shown in FIG. 2. For example, in an embodiment, the vehicle pricing system 12 can use user data stored in the user database 34A to geo-reference potential future customer referrals to the corresponding user. Data entered by users in various geo-locations can be used by the vehicle pricing system 12 to establish national price points for components of vehicles and components of vehicles of a particular make, model, and/or year. Moreover, prices of one or more specific components and/or commodities can be compared across different locations to generate indexing values for each location that reflect the differences in the prices. These indexing values can include overall values, values for different types of components/commodities, and/or the like. In any case, the pricing system 12 can use these indexing values to generate values in locations for which there may be little or no current data based on locations for which current data is available.

The vehicle pricing system 12 can catalog buyer datapoints stored in the buyer database 34C and assist the buyer 4 to determine optimal pricing strategies for the buyer's 4 future customer quotes. In this way, the vehicle pricing system 12 can assist the buyer 4 in “learning” price quote strategies for securing future business by making more accurate quotes to customers in his region.

Embodiments of the pricing system 12 can generate various reports for presentation to a user 2, a buyer 4, and/or the like. For example, the pricing system 12 can generate a report of the bills of sale over a specified time period. The report can include information on the vehicle purchased, the purchase price, the individual from whom it was purchased, a current location of the vehicle/where the vehicle was subsequently sent, etc. Such a report can enable the user 2 to easily identify the revenue received for the vehicles purchased using the pricing system 12. User 2 also can input data regarding any discrepancy between the estimated price generated by the pricing system 12 and an actual price received for vehicle, for components of the vehicle, and/or commodities included thereon. The pricing system 12 can use such discrepancy data to adjust estimates and quotes made in the future.

Embodiments of the pricing system 12 also can generate one or more reports corresponding to the vehicles purchased according to different groupings. Illustrative reports include the numbers of and/or total prices for vehicles purchased grouped by days of the week, months, purchaser (e.g., employee responsible for purchase), source of lead, one or more attributes of the seller (e.g., male or female, age, etc.), etc. Such reports can enable, for example, the user 2 to review marketing methods to identify solutions and/or timing that are effective and less effective for generating transactions.

Embodiments of the pricing system 12 also can generate one or more interfaces that enable the user 2 to input costs associated with the purchase and resale of vehicles. Such costs can include compensation paid to employees or contractors for retrieving the vehicle, removing one or more components, transferring the components to other buyers, etc. Similarly, costs can include fuel costs, transportation vehicle maintenance other costs, reimbursed expenses, etc. The user 2 can use such reports to identify an average cost per vehicle, which can subsequently be used to determine an overall price for the vehicle as described above.

While primarily shown and described as being utilized by a purchaser of a vehicle targeted for scrap or recycling, it is understood that embodiments of the pricing system 12 can generate interfaces for use by a seller of such a vehicle. In this case, a purchaser can provide information to the pricing system 12 regarding fixed costs, a minimum mark up, etc., which the pricing system 12 can sue to provide one or more quotes to a seller in response to a query regarding selling his/her vehicle for scrap. The interface can enable the seller to accept an offer, which can result in a sale upon confirmation of the details provided by the user 2, a dispatched driver, etc.

While shown and described herein as a method and system for generating pricing information for a mechanism, it is understood that aspects of the invention further provide various alternative embodiments. For example, in one embodiment, the invention provides a computer program fixed in at least one computer-readable medium, which when executed, enables a computer system to generate pricing information for a mechanism. To this extent, the computer-readable medium includes program code, such as the mechanism program 30 (FIG. 1), which enables a computer system to implement some or all of a process described herein. It is understood that the term “computer-readable medium” comprises one or more of any type of tangible medium of expression, now known or later developed, from which a copy of the program code can be perceived, reproduced, or otherwise communicated by a computing device. For example, the computer-readable medium can comprise: one or more portable storage articles of manufacture; one or more memory/storage components of a computing device; and/or the like.

In another embodiment, the invention provides a method of providing a copy of program code, such as the mechanism program 30 (FIG. 1), which enables a computer system to implement some or all of a process described herein. In this case, a computer system can process a copy of the program code to generate and transmit, for reception at a second, distinct location, a set of data signals that has one or more of its characteristics set and/or changed in such a manner as to encode a copy of the program code in the set of data signals. Similarly, an embodiment of the invention provides a method of acquiring a copy of the program code, which includes a computer system receiving the set of data signals described herein, and translating the set of data signals into a copy of the computer program fixed in at least one computer-readable medium. In either case, the set of data signals can be transmitted/received using any type of communications link.

In still another embodiment, the invention provides a method of generating a system for generating pricing information for a mechanism. In this case, the generating can include configuring a computer system, such as the computing unit 20 (FIG. 1), to implement the method of generating pricing information for a mechanism. The configuring can include obtaining (e.g., creating, maintaining, purchasing, modifying, using, making available, etc.) one or more hardware components, with or without one or more software modules, and setting up the components and/or modules to implement a process described herein. To this extent, the configuring can include deploying one or more components to the computer system, which can comprise one or more of: (1) installing program code on a computing device; (2) adding one or more computing and/or I/O devices to the computer system; (3) incorporating and/or modifying the computer system to enable it to perform a process described herein; and/or the like.

As used herein, unless otherwise noted, the term “set” means one or more (i.e., at least one) and the phrase “any solution” means any now known or later developed solution. The singular forms “a,” “an,” and “the” include the plural forms as well, unless the context clearly indicates otherwise. Additionally, the terms “comprises,” “includes,” “has,” and related forms of each, when used in this specification, specify the presence of stated features, but do not preclude the presence or addition of one or more other features and/or groups thereof.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A computer system for pricing a mechanism, the computer system including:
a set of computing devices configured to provide at least one composite price for the mechanism by:
managing a material pricing database for a plurality of materials, wherein the material pricing database includes a price for a quantity of each of the plurality of materials;
obtaining identifying information for the mechanism, wherein the identifying information defines a plurality of components included in the mechanism, and the plurality of components includes at least one materials-based component having a corresponding recyclable quantity of a material of the plurality of materials included in the materials-based component;
determining at least one price for each component of the plurality of components, wherein determining one of the at least one price for a materials-based component of the plurality of components includes determining a price for the corresponding recyclable quantity of the material included in the materials-based component;
calculating at least one composite price based on the determined at least one price for each of the plurality of components; and
providing the at least one composite price for use by a user.

2. The computer system of claim 1, wherein the managing the materials pricing database includes periodically updating the price for the quantity of each of the plurality of materials from at least one of: a purchaser of the material or a real time pricing system for the material.

3. The computer system of claim 1, wherein the set of computing devices is configured to manage an interface for acquiring selectable options data corresponding to a plurality of selectable options for the plurality of components of the mechanism, wherein the determining at least one price is further based on the selectable options data.

4. The computer system of claim 1, wherein the set of computing devices is configured to manage an interface for acquiring selectable pricing data corresponding to at least one selectable option for pricing a component of the plurality of components, wherein the determining at least one price is further based on the selectable pricing data.

5. The computer system of claim 1, wherein the calculated at least one composite price is further based on overhead costs for purchasing and/or disposing of the mechanism.

6. The computer system of claim 1, wherein the at least one composite price corresponds to one of a price a buyer is willing pay for the mechanism or a price a buyer can obtain by selling the plurality of components included in the mechanism.

7. The computer system of claim 1, wherein the mechanism is a vehicle, and wherein the at least one materials-based component includes a catalytic converter.

8. A computer system for managing a transfer of a mechanism, the computer system including:
a set of computing devices configured to arrange a transfer of the mechanism from a first owner to a second owner by:
providing at least one composite price for the transfer of the mechanism by:
managing a material pricing database for a plurality of materials, wherein the material pricing database includes a price for a quantity of each of the plurality of materials;
obtaining identifying information for the mechanism, wherein the identifying information defines a plurality of components included in the mechanism, and the plurality of components includes at least one materials-based component having a corresponding recyclable quantity of a material of the plurality of materials included in the materials-based component;
determining at least one price for each component of the plurality of components, wherein determining one of the at least one price for a materials-based component of the plurality of components includes determining a price for the corresponding recyclable quantity of the material included in the materials-based component;
calculating at least one composite price based on the determined at least one price for each of the plurality of components; and
providing the at least one composite price for use by a user;
receiving transfer data corresponding to the transfer from the user, wherein the transfer data includes a location of the mechanism and an agreed price for the mechanism; and
initiating a transfer of possession of the mechanism using the transfer data.

9. The computer system of claim 8, wherein the managing the materials pricing database includes periodically updating the price for the quantity of each of the plurality of materials from at least one of: a purchaser of the material or a real time pricing system for the material.

10. The computer system of claim 8, wherein the set of computing devices is configured to manage an interface for acquiring selectable options data corresponding to a plurality of selectable options for the plurality of components of the mechanism, wherein the determining at least one price is further based on the selectable options data.

11. The computer system of claim 8, wherein the set of computing devices is configured to manage an interface for confirming the identifying information for the mechanism.

12. The computer system of claim 8, wherein the set of computing devices is configured to generate data relating to a bill of sale for the transfer.

13. The computer system of claim 8, wherein the mechanism is a vehicle, and wherein the at least one materials-based component includes a catalytic converter.

14. A computer system for managing a transfer of a vehicle, the computer system including:
a set of computing devices configured to arrange a transfer of the vehicle from a first owner to a second owner by:
providing at least one composite price for the transfer of the vehicle by:
managing a material pricing database for a plurality of materials, wherein the material pricing database includes a price for a quantity of each of the plurality of materials;
obtaining identifying information for the vehicle, wherein the identifying information defines a plurality of components included in the vehicle, and the plurality of components includes at least one materials-based component having a corresponding recyclable quantity of a material of the plurality of materials included in the materials-based component;
determining at least one price for each component of the plurality of components, wherein determining one of the at least one price for a materials-based component of the plurality of components includes determining a price for the corresponding recyclable quantity of the material included in the materials-based component;
calculating at least one composite price based on the determined at least one price for each of the plurality of components; and
providing the at least one composite price for use by a user;
receiving transfer data corresponding to the transfer from the user, wherein the transfer data includes a location of the vehicle and an agreed price for the vehicle; and
initiating a transfer of possession of the vehicle using the transfer data.
